(19) United States
(12) Patent Application Publication
(10) Pub. No.: US 2006/0227009 A1
(43) Pub. Date: Oct. 12, 2006

(54) Truncated safety come warning system

(76) Inventor: Doyle L. Koehn, Arvada, CO (US)

Correspondence Address: Doyle L. Koehn, 5709 W. 71st Cir, Arvada, CO, 80003, US

(21) Appl. No.: 11/389,454

(22) Filed: Mar. 24, 2006

Related U.S. Application Data
(60) Provisional application No. 60/665,787, filed on Mar. 28, 2005.

(51) Int. Cl. G08G 1/07

(52) U.S. Cl. 340/925

(57) ABSTRACT

A TRUNCATED SAFETY DOME WARNING SYSTEM (also referred to as a “mat”) that is bonded to plurality of surfaces of walkways, crosswalks, highways, and any other areas of pedestrian or vehicular traffic for providing a warning to any one and especially a visually handicapped person is disclosed. The mat is a one piece formed mat that has a plurality of sizes and designs to conform the Americans with Disabilities Act (ADA) as of July of 2004 requirements. The mat is designed in order to keep objects from catching on the edges of the mat or domes causing the mat from be destroyed and or damaged. The mat and domes are designed to minimize a person from falling as a result of catching their shoe on the edge of the mat or edge of a dome. All of the mats edges are flush to the walking surface. The dome(s), because of their design allow snow plows and sharp objects to slid over the top on the dome(s). The truncated safety dome(s) are 3 to 4 times harder then concrete and when bonded to concrete, the only way to remove the truncated safety dome(s) is grind them off.

### CROSS-REFERENCE TO RELATED APPLICATIONS

This application claims the benefit of U.S. provisional application Ser. No. 60/665,787, filed 2005 Mar. 28, by Doyle L. Koehn, the entire contents of which are incorporated herein by reference.

### FEDERALLY SPONSORED RESEARCH

Not Applicable

### SEQUENCE LISTING OR PROGRAM

Not Applicable

### BACKGROUND OF THE INVENTION

1. Field of Invention

This invention relates to intersection, crosswalks, highways center lanes, danger zones, sidewalks, walkways, platforms, etc., whereby any person and especially for the sight impaired pedestrians will be made aware of the locations of potential hazards.

2. Prior Art

This invention relates a person who is walking or driving. The person will feel the safety domes with there feet or will hear the sound of the safety domes if they are driving thereby alerting them that they entering an area of potential danger. Pedestrians that have some type of disability need to have some type of warning system in place to alert them of the potential danger. The present invention relates to Intersections, crosswalks, highways center lanes, danger zones, sidewalks, walkways, platforms, etc., whereby any person and especially for the sight impaired pedestrians will be made aware of the Locations of potential hazards. There is a need in public transit facilities, for pedestrians to detect the locations of potential hazards. By making the pedestrian aware of a potential hazard, they can avoid the hazard. This hazard would include sidewalks, curb ramps, crosswalks, stairways, railroad crossings, subways platforms, loading docks, stages, bus loading platforms, man holes, potholes, construction area dangers, road edge warnings, intersections, highways center lanes, etc.

The Americans with Disabilities Act (ADA) as of July of 2004 established guide lines that the Truncated domes in a detectable warning surface shall have a base diameter of 0.9 inch minimum to 1.4 inches maximum, and the top of the dome diameter shall be 50% of the base diameter minimum to 65% of the base diameter maximum, and a height of 0.2 inch.

The Truncated domes in a detectable warning surface shall have a center-to-center spacing of 1.6 inches minimum and 2.4 inches maximum, and a bas-to-base spacing of 0.65 inch minimum, measured between the most adjacent domes on a square grid. Platform Edges: Detectable warning surfaces at platform boarding edges shall be 24 inches wide and shall extend the full length of the public use areas of the platform.

Known within the area of truncated dome warnings, there are many different designs for meeting the requirements of the ADA. There are tiles that are glued or mechanically fastened or imbedded into concrete. U.S. Pat. No. 4,715,743 to Schmanzki (1987), U.S. Pat. No. 5,303,669 to Szekely (1994), U.S. Pat. No. 0,031,415 to Sippola, (2005), U.S. Pat. No. 0,013,662 to Prozenzano (2005) There are mats where the domes are imbedded into the mats and fastened to the substrate by heat, rivets, glue, etc. All of the above have the same problems including the cost of installing; the time it takes to install; the need to retrofit on existing location or needing to build a custom lay out; snow plows, shovels, or sharp objects knocking the domes off and the way the domes are designed causes a safety problem. All of the domes are a ½ sphere, therefore snow plows knock the domes off and people who are unstable may stub their toes or stumble because of the design of the domes. All of the existing safety domes that have been made are made from cement, fiberglass, rubber, plastic, thermal plastic, tile (a combination of cement & polymer). None of which are made out of polymer with a plurality of fillers which makes a product that is 3 to 4 time harder than any concrete.

### OBJECTS AND ADVANTAGES

This invention relates to solving the problems that exist in all of the present truncated dome warning systems.

A. A mold is made into which liquid polymer is poured with a plurality of at least one or more of common mineral fillers, hardeners, accelerators, glass beads and skid resistant particles to produce the truncated dome mat.

B. The mold inside surface is blasted with course blasting compound to make the truncated dome mat have a abrasive texture for skid resistance.

C. As the truncated domes ware down, the imbedded glass particles & glass beads continue to provide the skid resistance.

D. The molds can be made in a plurality different geometric designs. The mold could be in the form of a “S”, “CURVE”, “TRIANGLE”, LINE TAPE”, “RECTANGLE”, CIRCLE, SQUARE, etc., and still maintain the “ADA” requirements.

E. The entire perimeter of the base “Truncated Dome Mat” starts with a “0” height to the substrate and has a plurality of degrees increase of about 15 degrees to 90 degrees to the top of the base height of the mat which has a plurality height of about 0.0625 inches to 4 inches.

F. The domes have a plurality height from about 0.1 inches to 0.3 inches above the “Mat Base”.

G. The base diameter of the truncated domes is plurality in distance of about 0.9 inches to 1.4 inches with the top of the domes having a plurality in distance of about 50% to 65% of the base diameter of the domes.

H. The Truncated domes in a detectable warning surface shall have a center-to-center plurality spacing of about 0.6 inches to 2.4 inches on a square grid with a base-to-base spacing of about 0.65 inches minimum between the most adjacent domes on a square grid.

I. The entire truncated dome mat has a plurality of common mineral fillers, hardeners, glass beads and skid resistant particles, with at least one embedded in the entire mat (base & domes), giving the mat additional safety.

J. Installation is done be using Degadeck® primer on the substrate and applying a coating of Degussa® 1004 binder resin with a plurality of fillers.

K. Mechanical fasteners are recessed into domes where needed and anchored into the substrate by drilling a 3/16 the hole into substrate.

### SUMMARY

The invention, an improved “Truncated Dome Warning System” is superior to any of the other types of detectable warning system in the following ways:

1. The entire invention is a one piece truncated domed mat made from polymer which is 3 to 4 times harder then concrete.

2. The truncated domed mat can be bonded to a plurality of surfaces and can only be removed by grinding the mat off.

3. By design the damage to mats and truncated domes as result of snow plows and sharp objects coming into contact with mates and truncated are greatly reduced.

4. By design the injury cause from tripping on the mats are greatly reduced. (presently, the best elevation on both the mat and the elevation on the truncated domes is 30 degrees) Everything slides over the top.

5. All edges start at a base of “0” and have a plurality elevation of about 15 degrees to 90 degrees. All edges of the said mat and domes have a plurality of radiuses This is true of both the base mat and the base of where the dome base begins. As an object comes into contact with the mat, the object will slide over the top of the mat or domes.

6. The truncated domed mats do not need any modification to the existing plurality of surfaces.

7. No reconstruction of the area where a detectable warning system is required. This invention is a retrofit system and can be install in 10 minutes

8. The truncated domed mats can be installed into new concrete because of the design we have on the truncated dome mats.

9. The truncated domed mats have a plurality sizes and shapes to meet the customer needs.

10. The truncated domed mats have a plurality of glass beads & skid resistant particles for safety.

11. There is a plurality of color pigments that are added to the polymer, giving the customer a choice of colors.

12. After installation, no barricades are needed because of the accelerators we are using in the bonding agent.

### DRAWINGS—FIGURES

FIG. 1 is a perspective top view of the flat surface of the truncated domed mat. In accordance with the invention, showing a section of the mat.

FIG. 2. is a perspective top view of the flat surface of the truncated domed mat as it is installed at a intersection crosswalk at a 45 degree angle.

FIG. 3 is a lateral cross-sectional view of the truncated domed mat of FIG. 1 showing the base mat and proposed lay out on base mat with truncated domes.

FIG. 4 is a lateral cross-section view of the truncated domed mat of FIG. 1 as it would be bonded to a plurality of surfaces.

FIG. 5. is a lateral cross-section view of a created mold 25 into which the polymer compound is poured to form FIG. 3. This created molding form 25 has the plurality of many different designs that will still meet the “ADA’ requirements and the customer.

FIG. 6. is a lateral cross-section view of FIG. 5. after it has been filled with polymer compound to form FIG. 3, FIG. 2, FIG. 1, (which is the truncated domed mat.)

FIG. 7 is a lateral cross-section of textured warning mat on concrete

FIG. 8 is a lateral cross-section of the receiving mold

FIG. 9 is a lateral cross-section of the textured warning mat

FIG. 10. is a lateral cross-section of the mold.

FIG. 11. is a lateral cross-section of the textured warning mat for concrete

FIG. 12. is a lateral cross-section of the textured warning mat installed in concrete.

### REFERENCE NUMERALS

11 truncated domed mat

11B. truncated domed mat

12 base diameter of the domes

13 top diameter of the top of domes

14 center to center spacing of domes

15 base to base spacing on a square grid

16 elevation angle of domes from the base of dome to the top of dome

17 elevation angle of “0” height of the edge to the base height of base mat

18 mechanical fasteners

19 height of domes from the base height of mat to the tope of domes

20 height of the base mat

21 bonding agent

22 surfaces upon which TRUNCATED SAFETY DOME SYSTEM is placed

23 primer

24 reduction of to amount of polymer mix

25 molding form into which polymer with fillers are poured to make the invention.

26 None

27 Increasing the quantity of polymer mix

28 Concrete

### DETAILED DESCRIPTION

All of the figures contain only a small portion of the entire mat. The entire mat is repeated as it is on a grid.

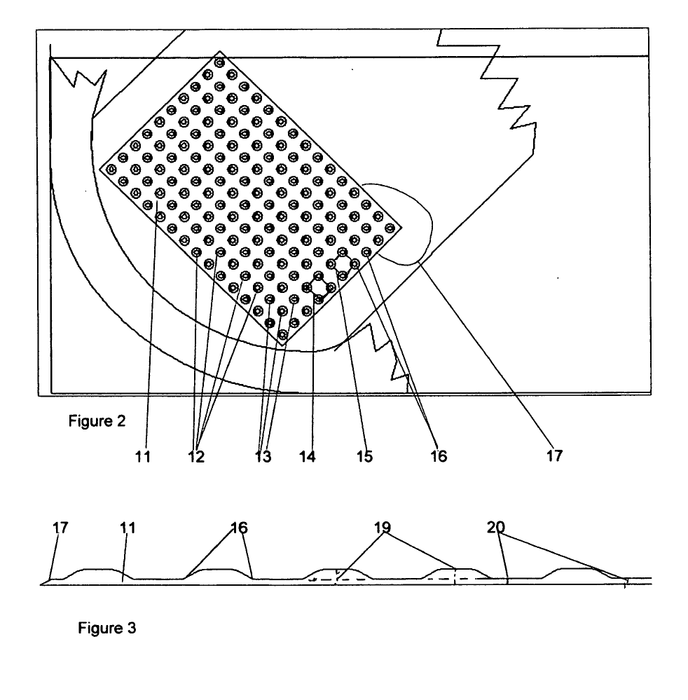

FIG. 1 is a perspective section view of the top surface of the TRUNCATED SAFETY DOME(S) WARNING SYSTEM 11 constructed in accordance with the invention. The base diameter 12 shall have a plurality diameter of about 0.9 inch minimum to a maximum of about 1.4 inches. The top of the domes 13 diameter shall have a plurality of about 50% to 65% of the base diameter 12. The Truncated domes in a detectable warning surface shall have a center-to-center plurality spacing 14 of about 1.6 inches to about 2.4 inches with as a base-to base spacing 15 of about 0.65 inches minimum between the most adjacent domes on a square grid. The elevation angle of the domes from the base of the dome 12 to the top of the dome 13 shall have a plurality in degrees 16 from about 15 degrees to 90 degrees which will allow any object coming into contact with any dome to slide over the dome. The outer edges of the Truncated Dome Mat 17 starts at “0” inches high and increases at a plurality in degrees incline about 15 degrees to 90 degrees. Which will allow any object coming into contact with the outer edge of the Truncated Dome Warning System to slide over the top.

FIG. 2. is a view of the TRUNCATED SAFETY DOME WARNING SYSTEM that is installed at a crosswalk having the requirements of the “ADA”. The mat 11 could have a plurality of sizes and designs. All ref. Numbers in FIG. 2 have the same description as in FIG. 1.

FIG. 3 is a lateral cross-section of mat 11. The domes have a height 19 of about 0.2 inches above the base height 20 which has a plurality height of about 0.0625 inches to 4 inches. # 17 & 16 give a view of the angle of for form 11.

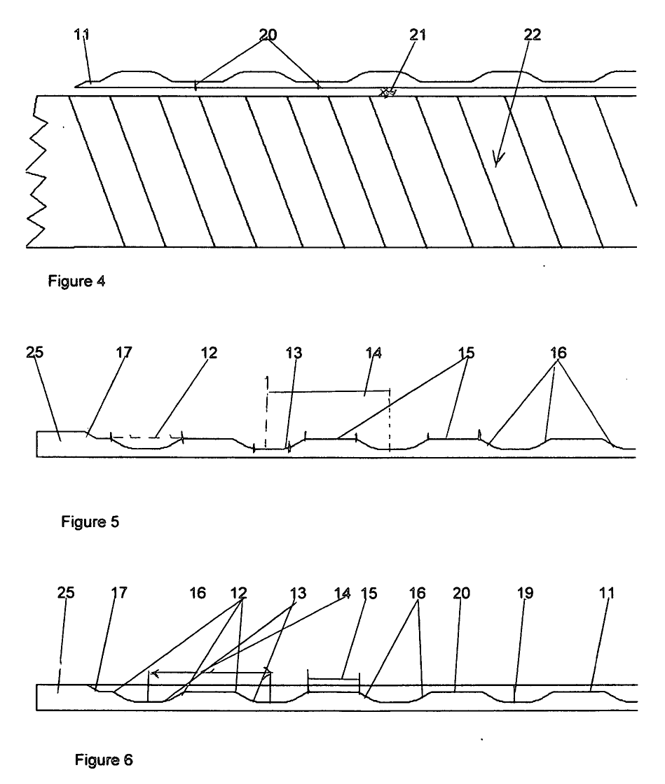

FIG. 4. is a lateral cross-section of truncated domed mat 11 as it is placed a plurality of surfaces 22. Between the truncated domed mat 11 and surface 22 a bonding agent 21 is placed to adhere the truncated domed mat 11 to the surface 22.

FIG. 5 is a lateral cross-section of the created casting mold 25 which shows 17 (the edge elevation of the truncated domed mat), 12 (the diameter of the base dome), 13 (the tope of the domes), 14 (the center of the dome to center of the domes), 15 (the distance between the base dome to base dome), 16 (the elevation angles of the base of the dome to top of dome).

FIG. 6. is a lateral cross-section of the created casting mold 25. into which is poured polymer mix with the plurality of at least one of the following: common mineral fillers, glass beads, skid resistant material, and color pigments. The finished product is the Truncated dome mate 11 which is three to 4 times harder than concrete, called the INVENTION: “TRUNCATED SAFETY DOME WARNING SYSTEM” The truncated dome mat 11 when taken out of the casting mold 25 is the finished product of the invention “TRUNCATED SAFETY DOME WARNING SYSTEM”

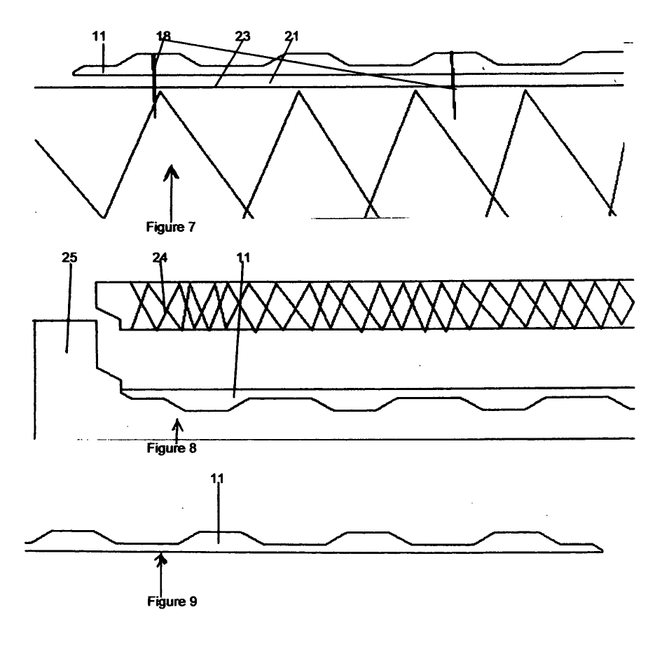

FIG. 7. is a lateral cross-section of the textured warning mat 11 as it is adhered to surface of a substrate, showing the mechanical fasteners 18 being installed as well as the bonding agent 21 and primer 23 being placed on the substrate.

FIG. 8 is a lateral cross-section of mold 25 whereby by reducing the amount of polymer mix 24 poured into the mold will produce the textured warning mat. 11

FIG. 9 is a lateral cross-section of the textured warning mat 11, which is a result of what took place in FIG. 8.

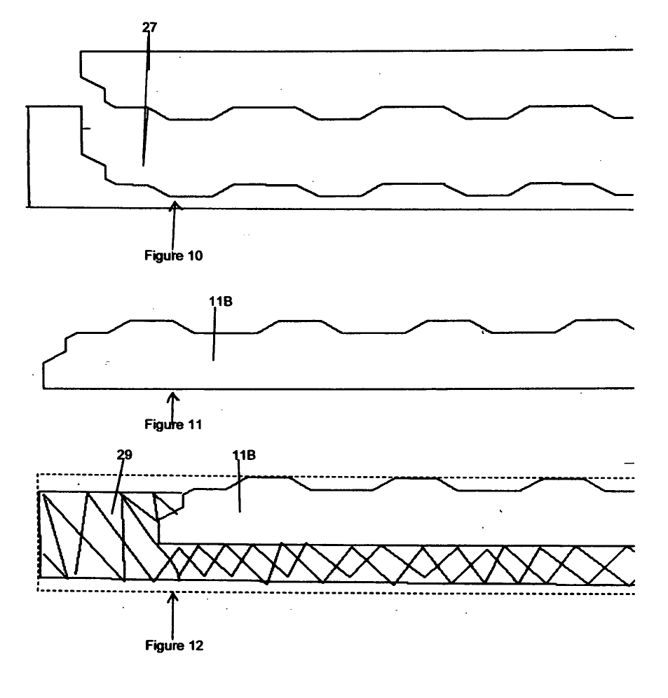

FIG. 10 is a lateral cross-section of the mold 25 whereby by increasing the amount of polymer mix 27 a textured warning mat 11B is produced that ready to be installed into the substrate.

FIG. 11 is a lateral cross-section of the textured warning mat 11B.

FIG. 12 is a lateral cross-section of the textured warning mat 11B installed in concrete.29

### OPERATION

The TRUNCATED SAFETY DOME WARNING SYSTEM (mat) is taken to location where there is a need for the (mat) to be placed. A primer is applied to the substrate and bonding agent is placed on the back side of the (mat). The (mat) is placed on surface, mechanical fasteners are counter sunk some of the domes as needed and drilled into the substrate. Within 10 to 20 minutes the TRUNCATED SAFETY DOME WARNING SYSTEM is ready to be used. There is no need to form out the surface where the (mat) will be placed. The TRUNCATED SAFETY DOME WARNING SYSTEM is a retro fitting system and therefore can be applied to any existing or new surfaces where “ADA” or other requirements apply. Objects coming into contact with the TRUNCATED SAFETY DOME WARNING SYSTEM will slide over the top of the (mat) because angle of elevation is always from 0 degrees to (between about 15 degrees to 90 degrees) from any side or any angle of approaching the TRUNCATED SAFETY DOME WARNING SYSTEM.

I claim:

1. A method of producing a textured warning mat on walkways, crosswalks and other areas of pedestrian traffic for providing direction and warning to visually handicapped persons, said method comprising: preparing a polymer mix filled with a plurality of fillers suitable for pouring said polymer mix into a receiving mold: wherein said receiving mold has a pattern embedded therein; adding coloring agent to form a concrete mix; pouring said polymer mix into said mold; allowing said polymer mix to cure forming said textured warning mat, wherein said textured warning mat has a plurality of raised elements formed on the top surface of textured warning mat.

2. A method as in claim 1, further comprising the steps of making receiving mold from a plurality of metals or plastics.

3. A method as in claim 1, wherein said mold has a plurality of rough textures to produce a skid resistant property to the textured warning mat.

4. A method as in clam 1, further comprising the steps of applying a plurality of hardeners, crushed glass and a plurality of common mineral fillers, one or more of which is added to said polymer mix.

5. A method as in claim 1, wherein said step of pouring said polymer mix into said mold provides a textured warning mat that is about 0.125 to 4 inches in thickness.

6. A method as in claim 1, wherein said raised elements are truncated dome(s).

7. A truncated dome as in claim 6, wherein said truncated dome(s) have a plurality of sizes.

8. A truncated dome as in claim 6, wherein said truncated dome(s) start at the base of the tope of the textured warning mat and have a plurality elevation of about 15° to 90° to the top of the truncated dome.

9. A truncated dome as in claim 6, wherein said truncated dome(s) all edges have a plurality of radiuses.

10. A method as in claim 1, wherein said truncated dome(s) are on a center to center square grid with a plurality of spacing.

11. A textured warning mat as in claim 1, wherein said textured warning mat has a plurality of geometric sizes and shapes

12. A textured warning mat as in claim 1, wherein said textured warning mat may be placed next to each other to form a plurality of shapes and designs.

13. A textured warning mat as in claim 1, wherein said textured warning mat base on all sides always starts at zero or at the top of substrate and shall have a plurality elevation of about 15° to 90°.

14. A textured warning mat as in claim 1, wherein said textured warning mat is flat on the bottom side.

15. A textured warning mat as in claim 1, wherein said textured warning mat on all edges have a plurality of radiuses.

16. A textured warning mat as defined in claim 1, wherein a plurality of bonding agents are applied to the bottom surface to bond the textured warning mat to the substrate.

17. A textured warning mat as defined in claim 1, wherein a plurality of mechanical fasteners are used attach the textured warning mat to the substrate.

18. A method of producing a textured warning mat on walkways, crosswalks and other areas of pedestrian traffic for providing direction and warning to visually handicapped persons, said method comprising: preparing a polymer mix filled with a plurality of fillers suitable for pouring said polymer mix into a receiving mold: wherein said receiving mold has a pattern embedded therein; adding coloring agent to form a concrete mix; pouring said polymer mix into said mold; allowing said polymer mix to cure forming said textured warning mat, wherein said textured warning mat has a plurality of raised elements formed on the top surface of textured warning mat.

19. A receiving mold as in claim 18, wherein said mold is made from a plurality of metals or plastics.

20. A method as in claim 18, further comprising the steps of making the said mold have a plurality of rough textures to produce a skid resistant property to the textured warning mat.

21. A method as in clam 18, further comprising the steps of applying a plurality of hardeners, crushed glass and a plurality of common mineral fillers one or more of which is added to said polymer mix.

22. A method as in claim 18, wherein said step of pouring said polymer mix into said mold provides a textured warning mat that is about 0.1875 to 4 inches in thickness.

23. A method as in claim 22, wherein said step of pouring said polymer mix into said mold will produce a textured warning mat that can be imbedded into new concrete.

24. A method as in clam 18, wherein said raised elements are truncated dome(s).

25. A truncated dome(s) as in claim 24, wherein said truncated dome(s) have a plurality of sizes.

26. A truncated dome(s) as in claim 24, wherein said truncated dome(s) start at the base of the top of the textured warning mat and have a plurality elevation is about 15° to 90° to the top of the truncated dome.

27. The truncated dome(s) 18, wherein said truncated dome(s) are on a square grid center to center with a plurality of spacing.

28. A method as in claim 18, wherein said textured warning mat has a plurality of geometric sizes and shapes

29. A textured warning mat as in clam 18, wherein said textured warning mat may be placed next to each other to form a plurality of shapes and designs.

30. A textured warning mat as in claim 18, wherein said textured warning mat base on all sides always starts at zero or at the top of substrate and shall have a plurality elevation of about 15° to 90°.

31. A textured warning mat as in claim 18, wherein said textured warning mat is flat on the bottom side.

32. A textured warning mat as in claim 18, wherein said textured warning mat on all edges have a plurality of radiuses.

33. A textured warning mat as defined in claim 18, wherein a plurality of bonding agents are applied to the bottom surface to bond the textured warning mat to the substrate.

34. A textured warning mat as defined in claim 18, wherein a plurality of mechanical fasteners are used attach the textured warning mat to the substrate.
